(19) United States
(12) Patent Application Publication
(10) Pub. No.: US 2013/0249683 A1
(43) Pub. Date: Sep. 26, 2013

(54) Theft Prevention Using Existing ABS Sensors

(71) Applicant: Keven Dale Coates, Cypress, TX (US)

(72) Inventor: Keven Dale Coates, Cypress, TX (US)

(73) Assignee: TEXAS INSTRUMENTS INCORPORATED, Dallas, TX (US)

(21) Appl. No.: 13/430,289

(22) Filed: Mar. 26, 2012

(51) Int. Cl. B60R 25/10

(52) U.S. Cl. 340/426.33

(57) ABSTRACT

The automobile theft prevention system proposed in this invention detects motion by using the existing wheel rotational sensors that are part of the anti lock braking and stability augmentation systems present in most automobiles, without the requirement of any additional hardware specific to the theft prevention system.

### TECHNICAL FIELD OF THE INVENTION

The technical field of this invention is automobile security systems.

### BACKGROUND OF THE INVENTION

A large number of theft prevention systems are available for automobiles. They range in complexity and function from very simple systems that simply detect that the car door was opened, to very complex ones employing an array of sensors that may include switches, pressure sensors, motion detectors, voltage monitors and acoustic sensors. They all have one parameter in common, the sensors are usually separate and distinct from the equipment normally available in the automobile.

One of the more difficult events to detect in a reliable manner is movement of the automobile that may indicate towing or pushing. Most of the existing systems use a motion sensor of some kind that are either not sensitive enough to detect slow movement, or are prone to an excessive rate of false alarms. The invention described shows a reliable motion detection system using sensors already installed in modern automobiles.

### SUMMARY OF THE INVENTION

Most modern automobiles are factory equipped with anti-lock braking systems (ABS), and with electronic stability control systems.

A typical ABS system includes a number of wheel speed sensors that continually monitor the rotational speed of the wheels, and a control unit capable of applying and/or moderating the braking force applied to each wheel. By determining any differences in rotation between the wheels. Any detected difference above a set threshold may indicate and incipient skid, and the ABS system may then reduce the braking force applied to that wheel to prevent loss of control.

The same sensors that are employed by the ABS system may also be used to detect unauthorized movement of the automobile by towing or pushing, and may be used to implement a theft prevention system without adding any additional hardware to the automobile.

### BRIEF DESCRIPTION OF THE DRAWINGS

These and other aspects of this invention are illustrated in the drawings, in which:

FIG. 1 illustrates a variable reluctance based position sensor;

FIG. 2 illustrates a magnetic reed switch based position sensor;

FIG. 3 shows a Hall Effect magnetic field sensor;

FIG. 4 illustrates a Hall Effect based position sensor;

FIG. 5 shows a flow diagram of the alarm arming logic; and

FIG. 6 shows a flow diagram of the alarm activating logic.

### DETAILED DESCRIPTION OF PREFERRED EMBODIMENTS

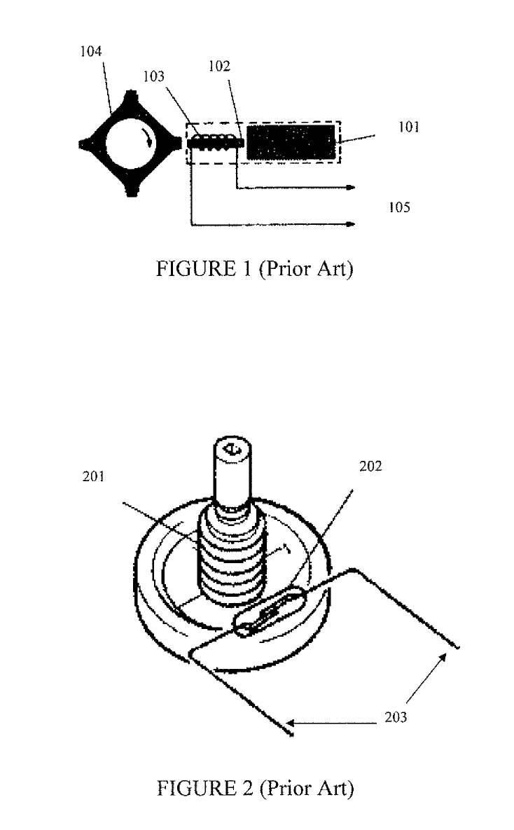

ABS systems may be implemented using a variety of sensors to detect and measure wheel movement. FIG. 1 shows a variable reluctance sensor where 101 is a permanent magnet in proximity to coil 102 wound on core 102. Rotor 104 is part of, or is attached to the wheel and has a number of lobes that pass in close proximity to coil 103 as the wheel rotates. Due to the change in magnetic field as the lobes pass the coil, a periodic voltage is generated in coil 103 whose frequency is representative of the wheel's rotational speed.

A simple magnetic reed switch may also be used to sense rotation. In FIG. 2 multi pole permanent magnet 202 is attached to the wheel, in close proximity to magnetic reed switch 202. Switch 202 will periodically open and close as the magnets pass by, thus alternately enabling and interrupting the current flow in connection 203. The rate of switch closure may be used to measure wheel rotation.

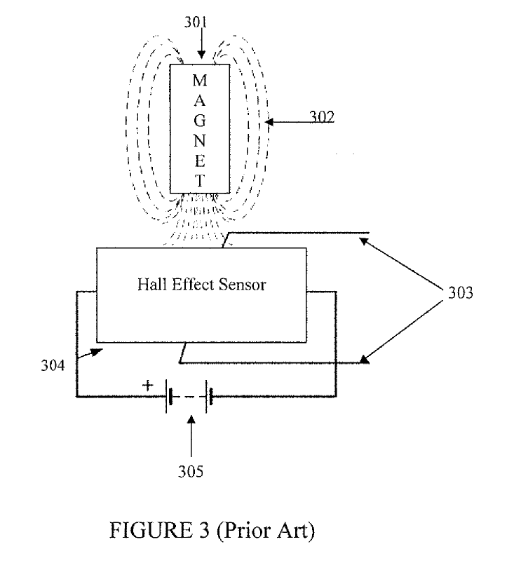

An alternate and very common sensor may also be constructed using a Hall Effect device. In FIG. 3 the Hall Effect device 304 is shown as a four terminal semiconductor device that will generate a signal on connection 303, that is proportional to the strength of the magnetic field 302 generated by permanent magnet 302.

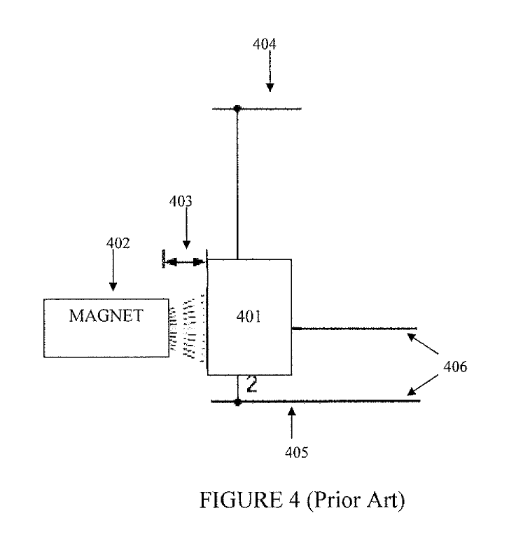

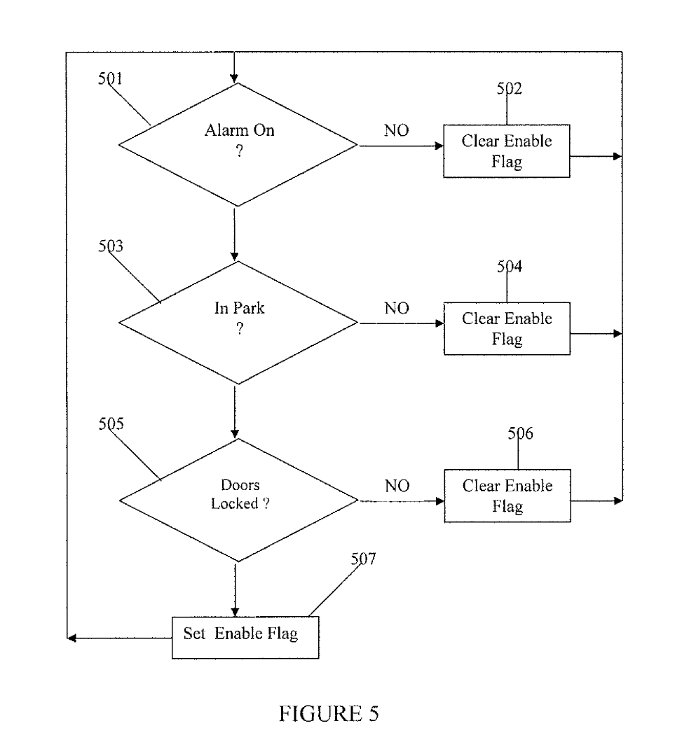

An implementation of a Hall Effect sensor to detect wheel rotation is shown in FIG. 4. Permanent magnet 402 may be attached to, or is part of the wheel. Hall Effect sensor 401 is in close proximity 403 from the rotating magnet 402, and will generate a signal proportional to wheel rotation on connection 406. In the illustration, connection 405 is usually at ground potential, and 404 is employed to apply a positive voltage.

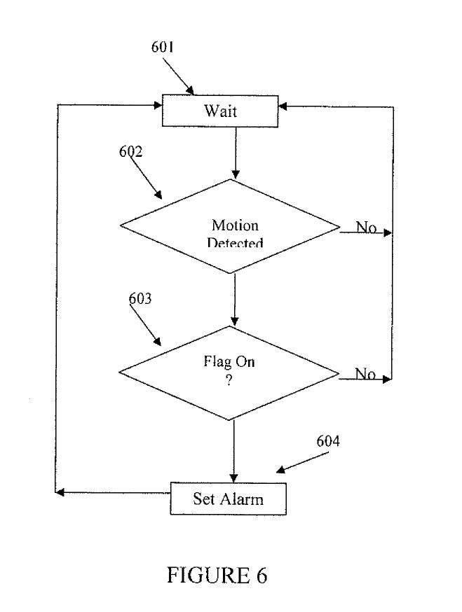

FIGS. 5 and 6 illustrate one implementation of the logic flow of a motion detection/alarm system employing the output of the ABS sensors. FIG. 5 shows the alarm enabling logic where block 501 detects if the alarm system is on or off. If the system is off, block 502 clears the enable flag if it is on. Block 503 detects if the transmission is in park. If not block 504 clears the enable flag if it is on. Lastly, block 505 detects if the doors are locked. If not, block 506 again clears the enable flag if it is on. If all the conditions are met indicating a valid alarm enable condition, block 507 sets the Enable flag.

The alarm activation logic flow is illustrated in FIG. 6, where block 601 implements a short time delay to reduce the possibility of false alarms due to vibration. Block 602 monitors one or more of the ABS wheel rotational sensors. If rotation is not detected, control returns to block 601. If rotation is detected, block 603 checks whether the Enable flag is set. If not, control flow returns to block 601. If the Enable flag is set, block 604 activates the alarm then returns control to block 601 to continue monitoring.

What is claimed is:

1. A method of automobile theft prevention comprising the steps of:
monitoring the status of a plurality of wheel rotation sensors, and
enabling or disabling the theft prevention system based on the automobile's status.

2. The method of claim 1 wherein:
theft is indicated when the theft prevention system is enabled, and the status of one or more of the wheel rotation sensors indicate wheel rotation.

3. The method of claim 1 wherein the wheel sensors are part of the anti lock braking system.

4. The method of claim 1 further comprising the step of:
sounding an audible alarm when theft is indicated.
